(19) United States
(12) Patent Application Publication
(10) Pub. No.: US 2022/0203824 A1
(43) Pub. Date: Jun. 30, 2022

(54) VEHICLE COMPONENT AND CONTROL METHOD THEREOF

(71) Applicant: Ford Global Technologies, LLC, Dearborn, MI (US)

(72) Inventors: Andrew Liu, Nanjing (CN); Eric Pan, Nanjing (CN); Xiuwei Yang, Nanjing (CN); Silver Zhou, Nanjing (CN); Roy Zhang, Nanjing (CN)

(21) Appl. No.: 17/552,729

(22) Filed: Dec. 16, 2021

(30) Foreign Application Priority Data
Dec. 29, 2020 (CN) 2020116033316

(51) Int. Cl. B60K 11/08; F01P 7/10

(52) U.S. Cl. CPC B60K 11/085; F01P 7/10

(57) ABSTRACT

The present disclosure provides a vehicle component comprising: at least two movable blades; and an actuator receiving an activation signal and driving at least one of the blades to move between a first position and a second position to exhibit a particular action. The present disclosure also provides a control method of the vehicle component, wherein the component comprises at least two movable blades. The control method comprises: driving the blade of the vehicle component to move between a first position and a second position based on an activation signal to exhibit a particular action. According to the present disclosure, the component and the control method thereof can meet people's demand for producing attractive visual effects with customized actions or patterns, and bring better vehicle use experience.

### CROSS-REFERENCE TO RELATED APPLICATIONS

This disclosure claims priority to Chinese Patent Application No. CN 2020116033316, which was filed on 29 Dec. 2020 and is incorporated herein by reference in its entirety.

### TECHNICAL FIELD

The present disclosure generally relates to vehicle technology field, and more specifically, to a vehicle component and a control method thereof.

### BACKGROUND

With the improvement of living standards and the increase in demand for vehicles, people not only pay attention to the inherent quality and performance of the vehicle, but also pay more attention to the vehicle's appearance, especially characteristics of the appearance that can be distinguish from other vehicles. Generally, people hope to form a significant visual difference with other vehicles through the appearance of the vehicle, in order to attract the attention of others and express their own personality.

At present, most of the components for vehicle decoration used on vehicles, such as vehicle grilles, rear spoilers, etc., cannot meet people's demand that produce attractive visual effects with customized actions or patterns. Moreover, in addition to exhibiting the role of decorating the vehicle, some components may also have other uses in some cases. Therefore, the improvement to vehicle components should not affect other functions of the components.

For example, in the active air intake grille system (AGS) used by many vehicles at present, the grille of AGS occupies a very prominent position in front of the vehicle, which is one of the common components in the vehicle. However, the current AGS is only used to provide controlled cooling air flow from the outside of the vehicle according to the orientation of its blades to control heat accumulation and reduce aerodynamic resistance, without considering providing a unique visual experience while meeting the air intake demand by using the AGS that can be controlled to move.

In addition, although some types of vehicles, such as pure electric vehicles (BEVs), do not need to control the heat accumulation through air intake from the front grille, it can still be considered to provide a unique visual experience through the controlled movement of the grille blades.

### SUMMARY

Under the above background, the inventor realized that there is a need for an improved vehicle component and a control method thereof, in order to meet people's demand of exhibiting customized patterns or actions through the component to achieve unique visual effects. Moreover, the improvements to component and the control method thereof can also be combined with existing component. The improvements, in addition to realizing the basic functions of the component, can also provide more unique visual experience at the same time, so that the vehicle can has more distinctive visual characteristics.

According to the present disclosure, there is provided a vehicle component comprising:

at least two movable blades; and an actuator receiving an activation signal and driving at least one of the blades to move between a first position and a second position to exhibit a particular action.

According to an embodiment of the present disclosure, the vehicle component is a vehicle grille. The at least two movable blades are located on a same grille bar, wherein the at least two movable blades are configured to exhibit a same action or different actions.

According to an embodiment of the present disclosure, the at least two movable blades are driven by a same actuator.

According to an embodiment of the disclosure, the component comprises different actuators for driving the at least two movable blades independently.

According to an embodiment of the present disclosure, the component comprises different actuators for driving a plurality of movable blades to different angles respectively.

According to an embodiment of the present disclosure, the at least two movable blades are configured to move independently of each other, and the particular action comprises different rotating actions of the at least two blades, wherein the different rotating actions comprise at least one of rotations at different times and rotations at different angles.

According to an embodiment of the present disclosure, wherein the at least two movable blades are arranged in a regular or irregular pattern longitudinally, laterally, along a curve or in other ways.

According to an embodiment of the present disclosure, the component is located on at least one of a rear end, door, and front end of the vehicle.

According to an embodiment of the present disclosure, the blades have the same or different shapes, and the shapes of the blades include triangle, polygon, ellipse, circle, sector, and other irregular shapes.

According to an embodiment of the present disclosure, the component further comprises a body control module configured to receive at least one of the following signals to generate the activation signal: an occupant approach signal, a vehicle unlock signal, a vehicle lock signal, a light drive signal, a remote-control signal, a sensor signal, and an action function activation signal.

According to an embodiment of the present disclosure, the vehicle comprises an engine, and the component is a vehicle grille, and the vehicle further comprises a powertrain control module for generating an intake air flow control signal; and

the body control module generates the activation signal, and the particular action of the at least one blade is terminated and reset when the actuator receives the intake air flow control signal.

According to an embodiment of the present disclosure, wherein the actuator receives the intake air flow control signal and the activation signal, and drives at least one blade of the grille to exhibit a second particular action based on the intake air flow control signal and the activation signal, wherein the second particular action is programmed to meet an air intake demand of the vehicle.

According to an embodiment of the present disclosure, when the engine is stopped or running, the actuator is configured to receive at least one of the following signals to generate the activation signal: an occupant approach signal, a vehicle unlock signal, a vehicle lock signal, a light drive signal, a remote-control signal, a sensor signal, and an action function activation signal.

According to an embodiment of the present disclosure, the component is a grille comprising:

a grille substrate;

a longitudinal linkage attached to the grille substrate;

a transverse linkage attached to the longitudinal linkage; and,

a drive linkage driven by the actuator, wherein the longitudinal linkage is attached to the drive linkage and driven by the drive linkage, wherein the grille comprises blades pivotally attached to the transverse linkage.

According to the present disclosure, there is provided a control method of the vehicle component, wherein the component comprises at least two movable blades. The control method comprises: driving the blade of the vehicle component to move between a first position and a second position based on an activation signal to exhibit a particular action.

According to an embodiment of the present disclosure, the control method comprises: receiving at least one of the following signals to generate the activation signal: an occupant approach signal, a vehicle unlock signal, a vehicle lock signal, a light drive signal, a remote-control signal, a sensor signal, and an action function activation signal.

According to an embodiment of the present disclosure, wherein the activation signal is generated when signal source of an occupant approach signal is within a particular range of the vehicle.

According to an embodiment of the present disclosure, wherein the activation signal is generated when a vehicle unlock signal or a vehicle lock signal is received.

According to an embodiment of the present disclosure, wherein the particular action comprises at least a pre-customized first particular action. The method comprises exhibiting the first particular action by driving at least one of the blades to move between the first position and the second position.

According to an embodiment of the present disclosure, wherein the particular action comprises at least a pre-customized second particular action. The method comprises exhibiting the second particular action by driving at least one of the blades to move between the first position and the second position. The second particular action is different from the first particular action.

According to an embodiment of the present disclosure, wherein the vehicle comprises an engine, and the component is a vehicle grille, wherein the activation signal is independent of an intake air flow control signal of the vehicle, and the activation signal is generated when the engine is off.

According to an embodiment of the present disclosure, wherein in response to the start of the engine of the vehicle, the particular action of the at least one blade is terminated and reset.

According to an embodiment of the present disclosure, wherein the method comprises driving at least one blade of the grille to exhibit the particular action based on the intake air flow control signal and the activation signal, wherein the particular action is programmed to meet an air intake demand of the vehicle.

According to an embodiment of the present disclosure, wherein the vehicle is an electric vehicle. The method comprises receiving at least one of the following signals to generate the activation signal when the engine is stopped or running: an occupant approach signal, a vehicle unlock signal, a vehicle lock signal, a light drive signal, a remote-control signal, a sensor signal, and an action function activation signal.

According to an embodiment of the present disclosure, wherein the vehicle comprises a plurality of blades that move independently of each other, and the particular action comprises the rotation of at least one blade.

According to an embodiment of the present disclosure, wherein the vehicle comprises a plurality of blades that move independently of each other, and the particular action comprises different rotating actions of at least two movable blades, and the different rotating actions comprise at least one of rotations at different times and rotations at different angles.

WA The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. In the figures, like referenced numerals may refer to like parts throughout the different figures unless otherwise specified.

FIG. 1 shows a schematic diagram of a motor vehicle with a component according to an embodiment of the present disclosure;

FIG. 2 shows a schematic diagram of a vehicle component according to an embodiment of the present disclosure;

FIG. 3 shows a flowchart of a control method of a vehicle component according to an embodiment of the present disclosure;

FIG. 4 shows a schematic diagram of a vehicle grille according to an embodiment of the present disclosure;

FIG. 5 shows an exploded schematic diagram of a vehicle grille according to an embodiment of the present disclosure;

FIG. 6 shows a flowchart of a control method of a vehicle grille according to an embodiment of the present disclosure;

FIG. 7 shows a flowchart of another control method of a vehicle grille according to an embodiment of the present disclosure.

### DETAILED DESCRIPTION

This Embodiments of the present disclosure are described below. However, it should be understood that the disclosed embodiments are only examples, and other embodiments may take various alternative forms. Drawings are not necessarily drawn to scale; and some functions may be exaggerated or minimized to show details of specific components. Therefore, the specific structural and functional details disclosed herein should not be interpreted as restrictive, but merely as a representative basis for teaching those skilled in the art to use the invention in various ways. As will be understood by those of ordinary skill in the art, various features shown and described with reference to any one of the drawings may be combined with features shown in one or more other drawings to produce embodiments which is not explicitly shown or described. The combination of the features shown provides a representative embodiment for a typical application. However, various combinations and modifications of features consistent with the teachings of the present disclosure may be expected for certain specific applications or embodiments.

One or more embodiments of the present application will be described below with reference to the accompanying drawings. The flowchart describes the process performed by the system. It can be understood that the execution of the flowchart does not need to be performed in order, one or more steps can be omitted, one or more steps can also be added, and the sequence or the reverse can be used. Even in some embodiments, one or more steps can be executed simultaneously.

The terms “driver”, “occupant”, “passenger” and “other clients of a same user” and so on involved in the following embodiments are used to illustrate the interaction between vehicle and user in one or more embodiments, and in some cases, the roles can be exchanged or other names can be used without departing from the spirit of the present application.

The motor vehicles involved in the following embodiments may be standard gasoline-powered vehicles, hybrid vehicles, electric vehicles, fuel cell vehicles and/or any other types of vehicles, and may also be buses, ships, or aircraft. Vehicles include components related to mobility, such as engines, electric motors, transmissions, suspensions, drive shafts, and/or wheels. The vehicle can be non-autonomous, semi-autonomous (for example, some conventional motion functions are controlled by the vehicle) or autonomous (for example, the motion functions are controlled by the vehicle without direct input from the driver).

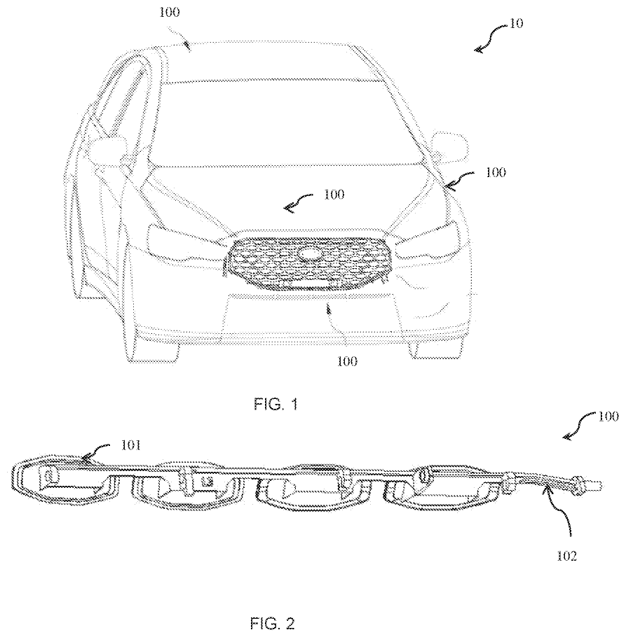

Referring to FIG. 1, an example of a vehicle 10 using a component of the present disclosure is shown, wherein the component 100 can be installed in various parts of the vehicle, for example, a grille at the front of the vehicle, a front cover of the vehicle, a side door of the vehicle, a top of the vehicle, and rear of the vehicle etc. In one or more embodiments of the present disclosure, the component 100 may be a trimming with a vehicle interior and/or exterior decoration function, or a functional trimming with other functions. The above-mentioned trimming comprises an interior trimming and exterior trimming. It can be understood that although the above-mentioned component is called the trimming, the interior trimming and the exterior trimming as trimming can still have other functions at the same time. For example, it may have at least one of an air intake adjustment function and a turbulence function, or realizing the design effect required by aerodynamics.

It should be understood that the use of the component 100 of the present disclosure in the various parts of the vehicle 10 above is only used as an example, and the use of the component 100 of the present disclosure in other internal or external parts of the vehicle 10 suitable for installation are also included in the scope of protection claimed by the component 100 of present disclosure.

As shown in FIG. 2, the vehicle component 100 of the present disclosure comprises two or more movable blades 101, and an actuator (not shown) that moves the two or more blades 101 between a first position and a second position to exhibit particular actions. Two or more blades 101 may be driven by the same actuator or by different actuators.

It should be understood that various types of actuators capable of actuating the movement of the blades 101 in the technical field can be used to actuate the component 100 of the present disclosure. The shape of the blade 101 may be one of a triangle, a polygon, an ellipse, a circle, a sector, and other regular or irregular shapes. In an embodiment, one blade 101 may also include a logo of the vehicle, a trademark of the vehicle, and the like. In one or more specific embodiments, the plurality of blades 101 separate from each other and can be independently adjusted.

Continuing to refer to the component 100 shown in FIG. 2, two or more blades 101 can be connected to a same linkage 102 or different transverse linkages 102, so that the blade 101 can be connected to an actuator through the transverse linkage 102. The actuator drives the transverse linkage 102 to lead the blade to rotate between the first position and the second position around a rotation axis, which may be a horizontal axis, a vertical axis or an inclined axis. And it is easy to understand that two or more blades 101 can be attached to one transverse linkage 102 according to the desired shape or pattern formed by the blades 101 and the requirements of decorating the vehicle 10. Two or more blades 101 can also be connected to different transverse linkages 102 to form different arrangements according to the desired shape or pattern and the requirements of decorating the vehicle 10. Furthermore, one or more blades 101 of the component 100 in the present disclosure may also be directly attached to the actuator and driven by the actuator to rotate around the rotation axis, which may be a horizontal axis, a vertical axis or an inclined axis, in addition to being driven by the actuator in a manner of being attached to the transverse linkage 102. It can be understood that other transmission methods known in the art can also be applied to the transmission between the actuator and the blade 101 of the component 100 of the present disclosure.

In the embodiment of the present disclosure, the vehicle 10 has a body control module. The actuator can receive an activation signal from the body control module, and drive the movement of two or more blades 101 based on the activation signal. The two or more blades 101 driven by the same actuator can perform a same rotating action and/or rotate to a same angle, while the two or more blades 101 driven by different actuators can perform different rotating actions, rotate to different angles or rotate according to a set time sequence, wherein the different rotating actions may be rotations at different times for example. It should be understood that the description of the above-mentioned rotation mode here is only an example of the present disclosure, and other rotation modes of the blade 101 are also included in the scope of the component 100 of the present disclosure.

In an embodiment of the present disclosure, two or more blades 101 of the component 100 may be arranged in a regular or irregular pattern longitudinally, laterally, along a curve or in other ways. In addition, the component of the present application can be arranged in various positions such as a rear end, a door, or a front end of the vehicle 10 to achieve the purpose of decorating the vehicle 10 from different angles. At the same time, it can be understood that the plurality of blades 101 may also be arranged in a matrix, and the motion form or the position of one or more blades 101 in the matrix can be driven by a program particular in the body control module to form the desired visual effect.

In an embodiment of the present disclosure, the plurality of blades 101 in the matrix of the component 100 can be driven by different actuators. The body control module controls the actuators to drive the plurality of blades 101 to move at different times through a pre-programmed program to form a unique visual effect. For example, the blades 101 can be moved in sequence according to a pre-programmed time sequence to form a flashing wave light effect by reflecting the light irradiated on the plurality of blades 101. Furthermore, the plurality of blades 101 may have a polygonal dragon scaly shape, to form an effect similar to the animal scales through the matrix arrangement of the dragon scaly blades 101. When the actuators are used to drive the dragon scaly blades 101 respectively, the component 100 can form an eye-catching animation effect on the decorated surface of the exterior or interior of the vehicle, for example, the animation effect of opening and closing scales or the animation effect of moving on the surface of the vehicle.

In addition, in an embodiment of the present disclosure, the plurality of blades 101 in the matrix of the component 100 can be driven by the actuator to move to a particular position. It should be understood that the plurality of blades 101 can be driven to a same position or different positions. And the plurality of blades 101 are configured to form a unique visual effect through the arrangement of blades 101 moved to the same position or different positions.

Furthermore, it can be understood that the plurality of blades 101 in the matrix of the component 100 of the present disclosure can also be driven by the actuator. The body control module can drive some of the blades 101 to a particular position to form a background pattern or text by the actuator according to a pre-programmed program, and drive the remaining blades 101 to move according to a particular action. The visual effect of the pattern or text formed by the stationary blade 101 and the visual effect formed by the blades 101 moving in accordance with a pre-programmed motion are combined to form a visual effect different from the above description.

It can be understood that the actuator in the embodiment of the present disclosure may be a fixed angle actuator, such as a fixed angle actuator with an angle of 30°, 60° or 90°. In the case that some blades 101 only need to be driven to a fixed angle or be driven to move between fixed angles, these blades 101 can be driven to a fixed angle or move between fixed angles by the fixed angle actuator, thereby the installation space and expense of the component 100 can be saved.

The body control module is configured to receive at least one of an occupant approach signal, a vehicle unlock signal, a vehicle lock signal, a light drive signal, a remote-control signal, a sensor signal, and an action function activation signal from various subsystems of the vehicle 10, and generate different activation signals based on the different types of the received signals.

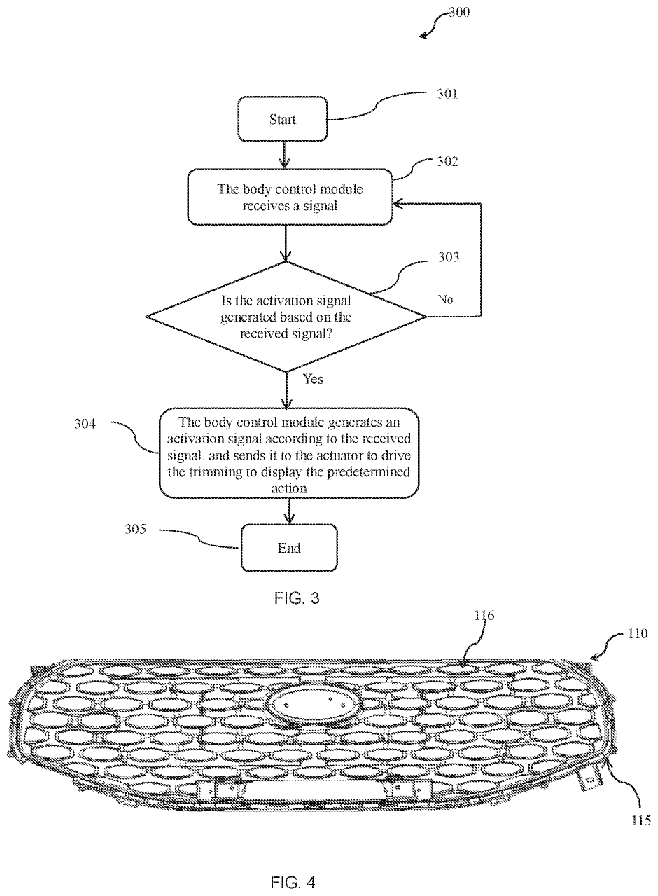

FIG. 3 shows a process 300 of a control method of the component of the present disclosure. The process 300 starts from step 301, and then in step 302, the body control module of the vehicle receives signals from the various subsystems of the vehicle. In the case of receiving a signal, in step 303, the body control module determines whether to generate an activation signal based on the source of the received signal. If an activation signal needs to be generated, in step 304, the body control module generates different activation signals based on the sources of the signals. If it is determined based on the received signal that there is no need to generate an activation signal, the process returns to step 302 to re-determine whether a new signal is received. It should be understood that the signal received by the body control module of the vehicle may be at least one of an occupant approach signal, a vehicle unlock signal, a vehicle lock signal, a light drive signal, a remote-control signal, a sensor signal, and an action function activation signal.

In step 304, the body control module sends different activation signals generated based on the different sources of the received signals to the actuator. Once receiving the activation signal from the body control module, the actuator will drive the blades of the vehicle component to move between the first position and the second position based on the activation signal to show a particular action. The particular action can be that the blades moves at a specific speed and opening angle between the first position and the second position. Or the particular action may also be that the blades open a specific angle between the first position and the second position to display a customized pattern to form different visual effects. Subsequently, the process 300 ends at step 305.

The process 300 of the above control method is only an example of a control method of the component of the present disclosure. In different scenarios, the above control method also has a variety of different control methods

In an embodiment of the present disclosure, when an occupant approaches the vehicle 10, the body control module receives an occupant approach signal. When the signal source of the occupant approach signal is within a particular range of the vehicle 10, the body control module determines that the occupant is within a visible distance of the vehicle and may be about to use the vehicle 10. Then the body control module can generate an activation signal to activate the movement of the blades 101 of the component 100 between the first position and the second position. A particular action is performed by the movement of the driving blades 101 or a regular or irregular pattern is formed by driving the blade 101 to different positions to form a decorative visual effect. A decorative visual effect is formed by driving the blades 101 to move to perform a particular action, or by driving the blades 101 to different positions to form a regular or irregular pattern.

For example, the blades 101 can be driven to move back and forth between different positions to express welcome to the occupants, or the blades 101 can directly be driven to different positions to form various patterns or texts to show the vision of welcome effect more directly. Certainly, in other examples, both the action and the composition of patterns and texts can be combined to achieve a welcome visual effect.

In a specific embodiment, the plurality of blades 101 are arranged along the transverse and longitudinal directions to form a matrix. The plurality of blades 101 can be driven to move at the same time to form a visual effect of scales/fins movement. In another specific embodiment, the plurality of blades 101 can be driven to move back and forth successively to form a ripple effect. The plurality of blades 101 can also be driven to move sequentially in a pre-programmed time sequence to form a flashing wave light effect by the reflection of light. It is possible that some of the blades 101 in the matrix are driven to a fixed position to form a background pattern, while the remaining blades 101 in the matrix are driven to move to form an animation effect of the scales/fins in the background pattern. It can be understood that the above description is only an example of the decorative visual effect formed by the component 100 of the present disclosure, rather than a limitation to the component of the present disclosure.

In the embodiment of the present disclosure, the movement of the blade 101 may include a plurality of particular actions. It can be understood that a plurality of particular actions are regarded as different particular actions. The preparation of the particular actions can proceed, for example, by the human-computer interaction interface of the on-board computer or the human-computer interaction interface of other smart devices that can communicate with the vehicle. One or more particular actions can be contained during one movement cycle of the blades, which starts from receiving the activation signal to move until stop moving. It can be understood that the above-mentioned movement cycle of the blades can be performed one or more times as required.

In another embodiment of the present disclosure, when the body control module receives the unlock signal or the lock signal of the vehicle 10, the body control module can also generate an activation signal to activate the movement of the component 100 to perform various particular actions described in the above-mentioned embodiment.

In another embodiment of the present disclosure, when the body control module receives the light activation signal of the vehicle 10, the body control module may generate an activation signal to activate the movement of the component 100 to perform various particular actions described in the above-mentioned embodiment.

In an embodiment of the present disclosure, a light of the vehicle 10 receives control signals from the body control module. The components 100 of the vehicle 10 may use the signal interface of the light to receive the activation signal from the body control module to perform particular actions. The signal interface is used by the body control module to send control signals to the light or component 100 through different time-sharing signals, frequency-division signals or different communication protocols, through which it is realized that the lights and the component 100 can receive signals in one direction independently, thereby interference and misjudgment between signals can be avoided. It can be understood that other communication methods sharing interfaces in the field can also be used for communication in the above-mentioned embodiment of the present disclosure.

In another embodiment of the present disclosure, when the body control module receives the remote-control signal, the body control module may generate an activation signal based on the received remote control signal to perform various particular actions described in the above-mentioned embodiment. For example, in the case that the vehicle 10 is a shared vehicle, when the occupant operates the vehicle 10 through the application (for example, open the door, lock the door, etc.), the remote server of the shared vehicle 10 will send a remote-control signal to the shared vehicle 10 to perform the operation of the vehicle 10

Furthermore, the remote-control signal can also appear, for example, in the case that the owner lent the vehicle 10 out. When the owner sends a remote-control signal to the vehicle 10 through the application, the body control module can generate an activation signal based on the received remote control signal to perform various particular actions described in the above-mentioned embodiment. For example, it is possible to receive a remote signal to show a welcome action or the like to the occupant who is about to use the vehicle 10.

In another embodiment of the present disclosure, in the case of receiving the sensor signal, the body control module can generate an activation signal based on the received sensor signal to perform various particular actions described in the above-mentioned embodiment. For example, in the scene of driving a vehicle to pick up passengers, when an on-board camera captures that the passenger has appeared in the filming range of the on-board camera, the signal can be sent to the body control module. The body control module generates an activation signal to make the actuator driving the blades 101 of the component 100 to form, for example, text or customized patterns of information related to the occupant, or welcome passengers through actions, so that the passenger can easily determine the vehicle 10 to be boarded and a good experience can be provided.

Furthermore, the body control module can also receive an action function activation signal, and generate an activation signal to drive the blades 101 of the component 100 to perform various particular actions in the above-mentioned embodiment. The action function activation signal can be, for example, an operation signal from a human-machine interface that directly operates the vehicle 10 or a human-machine interface of other smart devices that are communicatively connected with the vehicle 10.

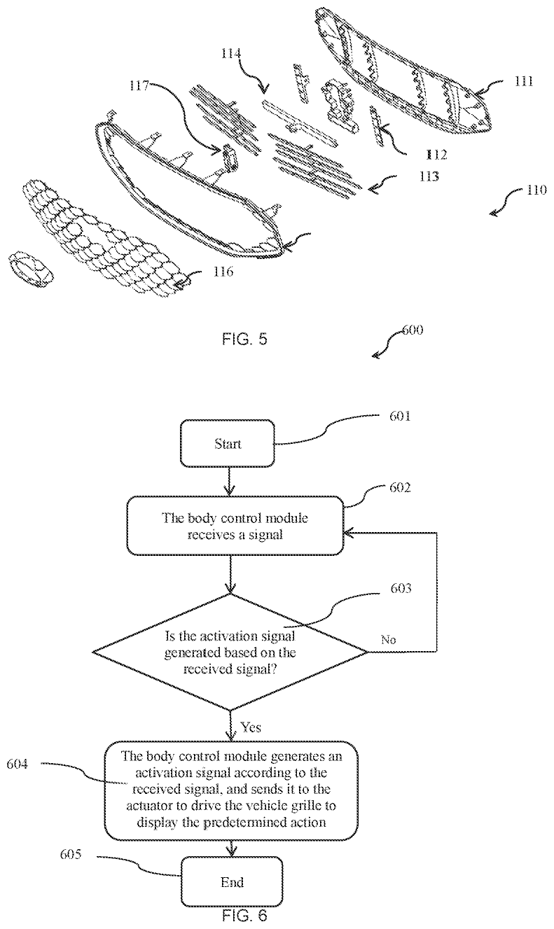

Next, FIGS. 4 to 5 show one embodiment of the component 100 of the present disclosure, which shows a grille 110 as the component 100 of the vehicle 10. In this embodiment, the grille 110 is held in the grille opening in the front fender panel of the vehicle 10. The grille 110 comprises a grille substrate 111, longitudinal linkages 112 fixedly connected to the grille substrate 111 in a vertical direction, and transverse linkages 113 attached to the longitudinal linkages 112 in a horizontal direction and configured to rotate around a horizontal axis. The longitudinal linkages 112 are attached to a drive linkage 114 and driven by the drive linkage 114 to rotate around a horizontal axis. It can be understood that the drive linkage 114 is actuated by at least one actuator 117. The actuator 117 may be various actuating devices known in the art that can actuate the drive linkage 114 or the blades 116. The plurality of blades 116 are attached to the transverse linkages 113 respectively and driven by the rotation of the transverse linkages 113 to move between a first position, which may be an open position of the air passage for example, and a second position, which may be a closed position of the air passage for example, to exhibit particular actions. The setting range of the plurality of blades 116 is defined by the grille frame 115.

It should be understood that the above description of the first position and the second position is only exemplary, and the first position and the second position may be any positions within the movable range of the blades 116 and should not be limited by the foregoing content. The blades 116 may have the same or different shapes, and the shape of the blades 116 may include a triangle, a polygon, an ellipse, a circle, a sector, and other regular or irregular shapes.

In an embodiment of the present disclosure, two or more movable blades 116 can be attached to a same linkage 113 or different transverse linkages 113. The two or more movable blades 116 can be driven by a same actuating device, or be driven by different actuating devices separately. When driven by the same actuating device, the two or more movable blades 116 can show a same action or be driven to a same angle. When driven by different actuating devices, the two or more movable blades 116 can show a same particular action or different particular actions, or be driven to a same particular angle or different particular angles, wherein the different particular actions may be rotations at different times or rotations according to a particular time sequence for example. The two or more movable blades 116 may be arranged in a regular or irregular pattern longitudinally, laterally, along a curve or in other ways to form a regular or irregular pattern. It can also be understood that the above description of the connection mode and movement mode of the blades 116 of the grille 110 is only an example, and other possible movement modes of the blades 116 of the grille 110 are also included in the scope of the present disclosure.

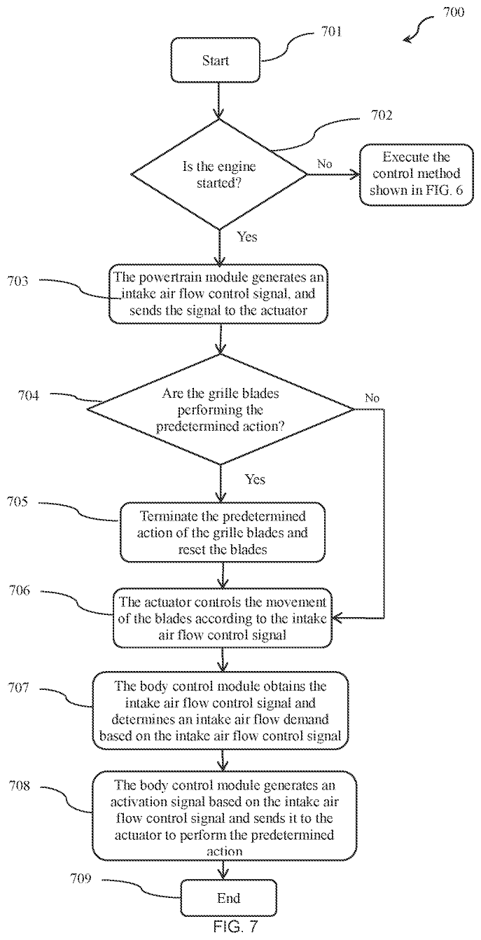

Next, with reference to the flowchart 500 of the control method of the grille shown in FIG. 6 and the grille 110 as an example of the component 100 in FIGS. 4-5, the grille 110 and its control method of this embodiment will be further explained.

The process 600 of the method starts from step 601, and then in step 602, the body control module of the vehicle receives signals from the various subsystems of the vehicle 10. In the case of receiving a signal, in step 603, the body control module determines the source of the received signal and generates different activation signals according to the different sources of the signals. If it is determined that there is no need to generate an activation signal based on the received signal, the process returns to step 602 to re-determine whether a new signal is received. It should be understood that the signal received by the body control module of the vehicle 10 may be at least one of an occupant approach signal, a vehicle unlock signal, a vehicle lock signal, a light drive signal, a remote-control signal, a sensor signal, and an action function activation signal.

Then in step 604, the body control module sends the generated activation signal to the actuator 117. Once receiving the activation signal from the body control module, the actuator 117 will drive the longitudinal linkages 112 of the vehicle based on the activation signal. Then the longitudinal linkages 112 drive the transverse linkages 113 to rotate around the horizontal axis, in order to drive the blade 116 to move between the first position and the second position, so that the vehicle grille 110 exhibits a particular action. The particular action can be that the blades 116 move at a specific speed and opening angle between the first position and the second position. Or the particular action may also be that the blades 116 open a specific angle between the first position and the second position to display different visual effects.

The above control method is only an example of one control method, and in different scenarios, the above control method also has a variety of different control methods.

In an embodiment of the present disclosure, when an occupant approaches the vehicle 10, the body control module receives an occupant approach signal. When the distance between the signal source of the occupant approach signal and the vehicle 10 is within a particular range, the body control module determines that the occupant is within a visible distance of the vehicle and may be about to use the vehicle 10. Then the body control module can generate an activation signal to activate the movement of the grille 110 and/or other component 100 of the body, to achieve its welcoming visual effect by driving the blade 116 to perform the particular. For example, the blades 116 can be driven to move back and forth between different positions to express welcome to the occupants, or the blades 116 can directly be driven to different positions to form text like “welcome” to show the vision of welcome effect more directly. In this embodiment, plurality of particular actions can be contained. For example, actions can be programmed by the human-computer interaction interface of the on-board computer or the human-computer interaction interface of other smart devices that can communicate with the vehicle. One or more particular actions can be contained in one action cycle of the blades 116.

In another embodiment of the present disclosure, when the body control module receives an unlock signal or a lock signal of the vehicle 10, the body control module can also generate an activation signal to activate the movement of the grille 110 and/or other component 100 of the body to perform various particular actions described in the above-mentioned embodiment.

In another embodiment of the present disclosure, when the body control module receives a light activation signal of the vehicle 10, the body control module may generate an activation signal to activate the movement of the grille 110 and/or other component 100 of the body to perform various particular actions described in the above-mentioned embodiment\

In another embodiment of the present disclosure, when the body control module receives a remote-control signal, the body control module may generate an activation signal based on the received remote control signal to perform various particular actions described in the above-mentioned embodiment. For example, in the case that the vehicle 10 is a shared vehicle, when the occupant operates the vehicle 10 through the application (for example, open the door, lock the door, etc.), the remote server of the shared vehicle 10 will send a remote-control signal to the shared vehicle 10 to perform the operation of the vehicle 10.

Furthermore, the remote-control signal can also appear, for example, in the case that the owner lent the vehicle 10 out. When the owner sends a remote-control signal to the vehicle 10 through the application, the body control module can generate an activation signal based on the received remote control signal to perform various particular actions described in the above-mentioned embodiment.

In another embodiment of the present disclosure, in the case of receiving the sensor signal, the body control module can generate an activation signal based on the received sensor signal to perform various particular actions described in the above-mentioned embodiment. For example, in the scene of driving a vehicle to pick up passengers, when an on-board camera captures that the passenger has appeared in the filming range of the on-board camera, the signal can be sent to the body control module. The body control module generates an activation signal to make the actuator drive the blades of the grille to form, for example, text or customized patterns of information related to the occupant, or welcome passengers through actions, so that the passenger can easily determine the vehicle to be boarded and a good experience can be provided.

Furthermore, the body control module can also receive an action function activation signal, and generate an activation signal to drive the blades of the grille to perform various particular actions in the above-mentioned embodiment. The action function activation signal can be, for example, an operation signal from a human-machine interface that directly operates the vehicle 10 or a human-machine interface of other smart devices that are communicatively connected with the vehicle 10.

Next, FIG. 7 shows a process 700 of the control method. In the embodiment of the control method, the vehicle 10 is a motor vehicle with an engine, and the component in this embodiment is embodied as a vehicle grille 110. The vehicle 10 here uses AGS. Unlike the activation signal of the vehicle grille 110 that received from the body control module to activate the decoration function, the intake air flow control signal of the AGS is generated by the powertrain control module of the vehicle 10. It can be understood that, in a vehicle with an engine, the powertrain control module may include an engine control module.

The process starts from step 701, and then in step 702, it is determined whether the engine of the vehicle 10 is started. If the engine of the vehicle 10 is not started, the control method shown in FIG. 6 above is executed. If the engine of the vehicle 10 is started, the process proceeds to step 703, in which the powertrain module of the vehicle 10 generates an intake air flow control signal and sends the signal to the actuator 117. Then in step 704, once receiving the intake air flow control signal, the actuator 117 determines whether the blades 116 of the grille 110 are performing the particular control action. If the particular control action is being performed, the action of the blades will be terminated and reset in step 705. Then in step 706, the actuator 117 controls the movement of the blades 116 based on the intake air flow control signal to meet the intake demand of the vehicle 10. If the blades 116 do not perform the particular control action, proceed to step 706 directly, in which the actuator 117 controls the movement of the blades 116 based on the intake air flow control signal to meet the intake demand of the vehicle 10.

Subsequently, in step 707, the body control module obtains the intake air flow control signal and determines the intake air flow demand based on the intake air flow control signal. Then in step 708, the body control module generates an activation signal based on the intake air flow control signal and sends it to the actuator 117, in order to execute the programmed particular action. It should be understood that the programmed particular action is programmed to meet the air intake demand of the vehicle 10.

Subsequently, the process 700 of the method ends in step 709. It should be understood that the body control module can determine the intake demand of the vehicle 10 at any time based on the received intake air flow control signal when the engine is started, and send different activation signals based on the change of the intake demand to adjust the particular control action.

It should be understood that in the case that all particular actions cannot meet the air intake demand, the body control module will not generate an activation signal, and the actuator will only drive the blades of the grille based on the intake air flow control signal generated by the powertrain control module to meet the intake air flow demand of the vehicle engine.

Where it is technically possible, the technical features listed in relation to different embodiments can be combined with each other to form further embodiment within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The term “including” is inclusive and has the same scope as “comprising”.

The above-mentioned embodiments are possible examples of implementations of the present disclosure and are given only for the purpose of enabling those skilled in the art to clearly understand the principles of the invention. It should be understood by those skilled in the art that the above discussion to any embodiment is only illustrative, and is not intended to imply that the disclosed scope of the embodiments of the present disclosure (including claims) is limited to these examples; under the overall concept of the invention, the technical features in the above embodiments or different embodiments can be combined with each other to produce many other changes in different aspects of embodiments of the invention that is not provided in detailed description for the sake of brevity. Therefore, any omission, modification, equivalent replacement, improvement, etc. made within the spirit and principle of the embodiment of the invention shall be included in the scope of protection claimed by the invention.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle component comprising:
at least two movable blades; and
an actuator that receives an activation signal and drives at least one of the blades to move between a first position and a second position to exhibit a particular action.

2. The vehicle component according to claim 1, wherein the vehicle component is a vehicle grille having a grille bar, the at least two movable blades are located on the grille bar, wherein the at least two movable blades are configured to exhibit a same action or different actions.

3. The vehicle component according to claim 1, further comprising an actuator that drives the at least two movable blades.

4. The vehicle component according to claim 1, further comprising a first actuator for driving a first one of the at least two blades and a second actuator for driving a second one of the at least two blades independently from the driving of the first one of the at least two blades.

5. The vehicle component according to claim 1, wherein the at least two movable blades are configured to move independently of each other, wherein the particular action comprises different rotating actions of the at least two blades, wherein the different rotating actions comprise at least one of rotations at different times and rotations at different angles.

6. The vehicle component according to claim 1, wherein the component is located on a front end of the vehicle.

7. The vehicle component according to claim 1, further comprising a body control module configured to generate the activation signal in response to receiving an occupant approach signal, a vehicle unlock signal, a vehicle lock signal, a light drive signal, a remote-control signal, a sensor signal, an action function activation signal, or some combination of these.

8. The vehicle component according to claim 7, wherein the vehicle comprises an engine, and the component is a vehicle grille, and the vehicle further comprises a powertrain control module that generates an intake air flow control signal; and
the body control module configured to generate the activation signal when the engine is off, and the particular action of the at least one blade is terminated and reset when the actuator receives the intake air flow control signal.

9. The vehicle component according to claim 8, wherein the actuator receives the intake air flow control signal and the activation signal, and drives at least one blade of the grille to exhibit a second particular action based on the intake air flow control signal and the activation signal, wherein the second particular action is programmed to meet an air intake demand of the vehicle.

10. The vehicle component according to claim 1, wherein, when the engine is stopped or running, the actuator is configured to generate the activation signal in response to receiving an occupant approach signal, a vehicle unlock signal, a vehicle lock signal, a light drive signal, a remote-control signal, a sensor signal, an action function activation signal, or some combination of these.

11. The vehicle component according to claim 1, wherein the component is a grille assembly having a grille substrate, a longitudinal linkage attached to the grille substrate, a transverse linkage attached to the longitudinal linkage, and a drive linkage configured to be driven by the actuator,
wherein the longitudinal linkage is attached to the drive linkage and driven by the drive linkage,
wherein the grille comprises blades pivotally attached to the transverse linkage.

12. A vehicle component control method:
providing a vehicle component having at least two movable blades; and
driving a first blade of the at least two movable blades to move the first blade between a first position and a second position based on an activation signal, the first blade driven to exhibit a particular action.

13. The method according to claim 12, further comprising generating the activation signal in response to receiving an occupant approach signal, a vehicle unlock signal, a vehicle lock signal, a light drive signal, a remote-control signal, a sensor signal, an action function activation signal, or some combination of these.

14. The method according to claim 12, further comprising generating the activation signal when an occupant approach signal is within a particular range of the vehicle.

15. The method of claim 12, wherein the activation signal is generated when a vehicle unlock signal or a vehicle lock signal is received.

16. The method according to claim 12, wherein the vehicle comprises an engine, and the component is a vehicle grille, wherein the activation signal is independent of an intake air flow control signal of the vehicle, wherein the activation signal is generated when the engine is off.

17. The method according to claim 16, further comprising driving at least one blade of the vehicle grille to exhibit the particular action based on the intake air flow control signal and the activation signal, wherein the particular action is programmed to meet an air intake demand of the vehicle.

18. The method according to claim 12, wherein the vehicle is an electric vehicle, wherein the method includes generating the activation signal in response to receiving an occupant approach signal, a vehicle unlock signal, a vehicle lock signal, a light drive signal, a remote-control signal, a sensor signal, an action function activation signal, or some combination of these.

19. The method according to claim 12, wherein the vehicle comprises a plurality of blades that move independently of each other, and the particular action comprises rotation of at least one blade.

20. The method according to claim 12, wherein the vehicle comprises a plurality of blades that move independently of each other, and the particular action comprises different rotating actions of at least two movable blades, and the different rotating actions comprise at least one of rotations at different times and rotations at different angles.
